(19) United States
(12) Patent Application Publication
(10) Pub. No.: US 2003/0135446 A1
(43) Pub. Date: Jul. 17, 2003

(54) Contingent convertible financial instruments

(76) Inventors: James R. Birle JR., Summit, NJ (US); Jeffrey N. Edwards, Basking Ridge, NJ (US); Yonathan Epelbaum, New York, NY (US); Frederick J. Fiddle, Ridgewood, NJ (US); Emerson P. Jones, Greenwich, CT (US); Stuart C. Kaperst, New York, NY (US); Todd K. Kaplan, Winnetka, IL (US); Daniel Y. Kerstein, Woodmere, NY (US); Richard P. Luciano, Morristown, NJ (US); Thomas H. Patrick JR., New York, NY (US); Paul A. Pepe, New York, NY (US); Eric Steifman, New York, NY (US); Russell L. Stein, Englewood Cliffs, NJ (US); Brennan J. Warble, Bronxville, NY (US); Richard J. Green, Woodbury, NY (US)

Correspondence Address: OPPEDAHL AND LARSON LLP, P O BOX 5068, DILLON, CO, 80435-5068, US

(21) Appl. No.: 10/064,744

(22) Filed: Aug. 12, 2002

Related U.S. Application Data
(60) Provisional application No. 60/311,516, filed on Aug. 10, 2001.

(51) Int. Cl. G06F 17/60

(52) U.S. Cl. 705/37; 705/40

(57) ABSTRACT

A contingent convertible debt instrument contains a provision permitting conversion only if any of certain economically substantial contingencies is satisfied. For example there may be a provision that conversion is permitted only if the issuer's stock price reaches some price, defined as some predetermined price substantially higher than the conversion price, is reached. This contingent conversion trigger price may be 110% or 120% more of the conversion price. The debt instrument may be a negotiable long-term zero-coupon note, and a provision may be included that the number of underlying instruments issuable or deliverable at conversion or exchange is adjusted under certain circumstances (e.g., merger, acquisition, or formulae amounts). Corresponding methods and systems are employed for offering and servicing such financial instruments.

### CROSS REFERENCE TO RELATED APPLICATIONS

This application claims priority from U.S. application Ser. No. 60/311,516, filed Aug. 10, 2001, which application is hereby incorporated herein by reference.

### BACKGROUND OF INVENTION

This invention relates generally to convertible and exchangeable financial instruments (e.g., debt instruments, preferred instruments, trust preferred instruments, warrants, certain insurance contracts, and suitable derivatives thereof, or any security backed by any of the above) and methods and systems for offering and servicing the same, and relates more particularly to financial instruments which are convertible into equity instruments.

A common financial instrument is a bond. A bond (more generally termed a “debt instrument”) is an instrument having language indicative of a principal amount, and having further language indicative of a borrower's obligation to repay the principal at some future time. Some bonds have still more language indicative of the borrower's obligation to make interest payments at specified times. Other bonds, called “zero-coupon” bonds, do not have language obligating the borrower to make interest payments in cash prior to maturity. Bonds, and the borrowing accomplished by means of such bonds, have been known for centuries.

Many financial instruments, including many bonds, are “negotiable,” meaning that the holder may freely sell the instruments to others with few if any restrictions. Such negotiability helps to provide a fluid and efficient market in which the instruments may be bought and sold at everprices indicative of the value given by the market to the instruments. A would-be borrower benefits from negotiability in many ways, for example because a lender is more willing to lend (to purchase the debt instruments) if it knows there is the prospect of selling the debt instruments to others at a later time. Negotiable bonds, and the borrowing accomplished therewith, have been known for over a century.

Many business entities will have the ability to raise money by means of a mix of debt instruments (e.g. bonds) and equity instruments (e.g. stock). The mix selected by a particular business entity will be influenced in a general way by prevailing interest rates, as well as by other factors such as the extent to which the market at a particular moment is willing to purchase newly issued instruments of one type or the other. Further, a particular business entity will have particular business circumstances which influence this mix, such as the amount of debt already outstanding, the entity's bond credit rating, and the price-to-earnings (P/E) ratio for the entity's stock. Because the entity's financial condition (particularly for publicly held entities) is reported according to generally accepted accounting principles, the effect on the reported financial condition of a particular change to this mix is often an important factor influencing this mix. Finally, the tax treatment of a particular change to this mix is also often an important factor influencing such decisions.

example of a convertible security, such as those which are termed “convertible bonds,” are instruments which have some of the qualities of bonds as well as some of the qualities of stock. A convertible bond is a bond which can be converted by its holder into a number of shares of equity, the number being a fixed number or being determined by a formula. It is thus possible to define a “conversion ratio”which is the number of shares of common stock that could be obtained by converting each share of the convertible instrument. In many instruments the conversion ratio is a constant over the term of the instrument, though in some instruments there may be a provision that the conversion ratio will change over the term of the instrument. Alternatively, the instrument may state a “conversion price” per share. With such an instrument the conversion price is divided into the par value of the bond to determine the number of shares available in the conversion. The instrument may contain a provision that this ratio may change over time.

The prior art contains convertible securities in which the ability to convert is dependent upon the passing of time. For example, with some prior-art convertible securities, conversion is not possible until after some predetermined date.

At issuance, the value of the bond is typically greater than the value of the fixed number of shares into which the bond is convertible. For example, a bond may be issued for $1,000 with a right to convert into ten shares of the issuer's common stock, at a time when the current market value per share is $83. Ordinarily, under these terms, the stock would have to appreciate to at least $100 per share before it would be economically rational for the holder to exercise its right to convert the bond. A convertible bond of this kind is described as having a roughly 20-percent conversion premium, because the stock must appreciate about 20 percent (i.e. $17) before the conversion right has intrinsic value. This conversion premium may be thought of as the dollar or percentage amount by which the price of the convertible instrument exceeds the current market value of the common stock into which it could be converted. It is thus possible to define a “conversion value”which is the value of a convertible security if it is converted immediately.

Some convertible bonds also provide that the issuer may call the instrument (repay it before the end of the term of the bond) after a number of years, subject to the holder's conversion rights. If at the time of the call the value of the stock has risen above the value of the debt, the holder generally will choose to exercise its conversion right so that it receives the stock rather than the call redemption amount.

It is instructive, then, to compare a bond that is convertible, and a bond that is not, from the point of view of the would-be purchaser (the investor) and from the point of view of the issuer. Because the conversion right provides an investor with a possible upside (related to the possible appreciation of the stock price) that the fixed-rate debt of the issuer would not provide, the interest rate on convertible instruments may be lower than the interest rate on fixed-rate instruments. Stated differently, the conversion right may be thought of as an option to acquire issuer stock, and the lower rate of interest compensates the issuer for providing this option. It is thus possible to define a “premium over bond value”which is the positive difference between the market price of a convertible bond and the price at which that bond would sell without the convertibility feature.

For the issuer who is trying to decide whether to issue a convertible instrument or a noninstrument, the convertible instrument traditionally has the drawback that an issuer may have to account for the shares underlying the bond as if they had been issued, in which case it may have an unfavorable effect on a corporation's Earnings Per Share (“EPS”).

It would be desirable to provide financial instruments, and methods and systems for offering and servicing such financial instruments, that provide issuers with a financial instrument that is not initially disadvantageous as to the calculation of earnings per share.

A further problem can arise for would-be purchasers of debt instruments. A would-be purchaser (or an underwriter in a position to underwrite issuance of such instruments) may find that potential issuers of such instruments are not easy to find. It is then extremely desirable if the underwriter is able to devise some significant and nontrivial variant on the priordebt instruments, which variant is somehow of interest to potential issuers when prior-art debt instruments would not be of interest.

Much effort has thus been expended in recent years to attempt to devise new and different debt instruments, and particularly, new and different convertible debt instruments, which offer advantages over those in the prior art. These efforts necessarily entail devising methods and systems for offering and servicing such financial instruments. It is noted in passing that U.S. Pat. No. 5,062,666 to Mowry et al. has claims directed to a financial instrument per se. That particular financial instrument is not, apparently, directed toward the problems described herein.

Experience shows, however, that the majority of such efforts are unavailing. In some markets, for example, it may be extremely difficult to devise an instrument which somehow works sufficiently to the advantage of both issuer and purchaser to make possible the issuance of the instrument.

If it were possible to devise a convertible debt instrument, or a family of convertible debt instruments, which through their provisions somehow bring about successful market transactions that would otherwise not be possible, this would work to the advantage of issuers and investors. It would, furthermore, make a meaningful contribution toward a more vigorous, more active, and more efficient capital market, thus benefitting the general public as well as particular market participants.

### SUMMARY OF INVENTION

A contingent convertible debt instrument contains a provision permitting conversion only if any of certain economically substantial contingencies is satisfied. For example there may be a provision that conversion is permitted only if the issuer's stock price reaches some price, defined as some predetermined price substantially higher than the conversion price, is reached. This contingent conversion trigger price may be 110% or 120% more of the conversion price. The debt instrument may be a negotiable long-term zero-coupon note, and a provision may be included that the number of underlying instruments issuable or deliverable at conversion or exchange is adjusted under certain circumstances (e.g., merger, acquisition, or formulae amounts). Corresponding methods and systems are employed for offering and servicing such financial instruments.

### BRIEF DESCRIPTION OF DRAWINGS

The invention will be described with respect to a drawing in several figures, in which like reference characters refer to like parts throughout, and in which:

FIGS. 1-4 are flowcharts of illustrative steps involved in issuing and servicing contingently convertible financial instruments in accordance with some embodiments of the present invention;

FIG. 5 presents the illustrative information flow for issuing and servicing financial instruments, in accordance with some embodiments of the present invention; and

FIG. 6 is illustrative of an exemplary system for implementing the method in accordance with some embodiments of the present invention.

### DETAILED DESCRIPTION

A contingent convertible debt instrument contains a provision permitting conversion only if any of certain economically substantial contingencies is satisfied. For example there may be a provision that conversion is permitted only if the issuer's stock price reaches some price, defined as some predetermined price substantially higher than the conversion price, is reached.

As mentioned earlier, the prior art contains convertible debt instruments in which conversion is possible only upon satisfaction of conditions relating to the passage of time. For example, some such instruments are convertible only after a predetermined interval has elapsed since the instruments were issued. The term “contingency”as applied here to contingently convertible debt instruments does not embrace such mere time-related conditions for convertibility. As will be appreciated, mere time-related conditions for convertibility do not necessarily provide the benefits described herein in connection with the invention, such as improved treatment under accounting rules relating to dilution and earnings-per-share calculations. The term “contingency”as applied here may, among other things, refer to economically substantial contingencies which permit improved accounting treatment as described herein, and which give additional control to the issuer regarding when and whether conversion or exchange may take place.

The present invention is a contingently convertible or exchangeable financial instrument, and systems and methods for offering and servicing the same. In accordance with some embodiments, the instruments may be based on, for example, short or long-term (20-30 year) zero coupon instruments. These may be long-term zero coupon notes such as Liquid Yield Option Notes (“LYONs”) offered by Merrill Lynch. They may be cash-pay or partial-cash-pay convertible bonds, debt instruments, preferred instruments, trust preferred instruments, warrants, certain insurance contracts, suitable derivatives thereof, or any securities backed by any of the above. The issuer of a contingently convertible instrument may be, for example, a publicly-traded, widely-held company sometimes referred to herein as the issuer of the instrument. The issuer of the financial instrument may allow contingent conversion of the instrument in certain circumstances or under certain formulae calculations.

The contingency may be one in which when the closing sale price of the shares for at least a prenumber of trading days prior to the day of surrender is required to be more than a prepercentage, for example, greater than 100%, or 110%, or 120% of the conversion price, for example, per common share or such preceding trading day.

The contingency may be that conversion is permitted when such instruments have been called for redemption.

The contingency may be that conversion is permitted upon the occurrence of certain corporate transactions such as significant distributions to shareholders, mergers, or consolidation.

The contingency may be that conversion is permitted during a period in which the credit rating of the instrument is below a specified level.

The contingency may be that conversion is permitted when the financial instrument is trading at less than, equal to, or greater than a pre-determined value or formulae amounts.

The contingency may be that conversion is permitted depending upon other formulae based on the value of the financial instrument, another financial security, or an index amount of a reference security, or a pool of securities or indices, or both.

For example, assume a contingent conversion long-term zero-coupon instrument is issued on Jun. 5, 2001. Using the $1,000 price of the bond discounted by a yield of 2.0%, the price of the bond is calculated at issue to be $671.65. The stock price at issuance is $100.00. The initial conversion premium of 30% is applied to the stock price to calculate the initial conversion price of $130.00. The initial bond price of $671.65 divided by the initial conversion price of $130.00 will result in the conversion ratio of 5.1665. A trigger of 120%, which may decrease over time, may be multiplied by the conversion price to determine the trigger price at which time the conversion may be available to holders. This 120% figure for the trigger represents a 20% level by which the stock price must rise above the conversion price for conversion to be permitted.

In some embodiments, such a contingency may be satisfied, for example, upon an issuer's optional redemption, or as a result of certain change of control events or anti-dilution provisions.

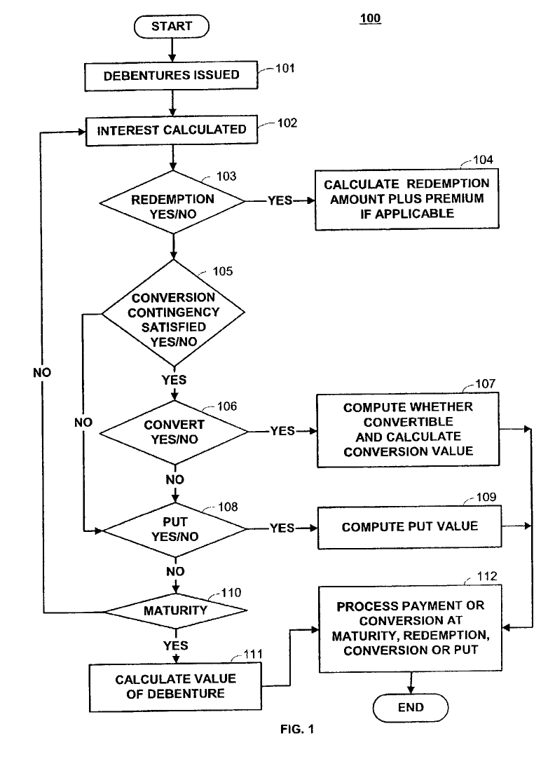

FIG. 1 is a flowchart of the illustrative steps involved in issuing and servicing contingently convertible financial instruments in accordance with some embodiments of the invention. The method starts at step 101 where a company, or other entity, issues a financial instrument (e.g., a debenture). A certificate may or may not be issued to a holder of an instrument, and bookkeeping entries indicative thereof may be maintained by a responsible entity. Furthermore, at step 101, the original principal amount of an instrument may equal an amount based on pre-determined terms.

The method then proceeds to step 102, where interest payments are calculated. step 103, if the issuer decides to redeem the instrument, the method proceeds to step 104 to calculate the redemption price. In a preferred embodiment, when a company decides to redeem its instruments, it may redeem some or all of the instruments issued under the same offering. Moreover, if the instruments are redeemed before a pre-selected date, the system may add a premium to the redemption amount. At step 105 it is determined whether the conversion contingency is satisfied.

The holder, under step 106, may convert the instrument to the underlying security if the contingency is met, computed at 107. The method may either allow a or exchange at any time after issue, or may require that conversions or exchanges occur during an allocated period of time after issue.

At step 108, the method draws upon information indicative of whether the holder decided to put the security. If yes, the method, at step 109, computes the put value.

As is well known in the art, a “put”is an option that gives the holder the right to sell a certain quantity of an underlying security to the writer of the option, at a specified price (called a “strike price”) up to a specified date (called the “expiration date”).

If, however, the method finds that the holder has not indicated that it wants to put the security at step 108, the method proceeds to step 110. At step 110, the bond has reached maturity and the method then calculates the value of the instrument under step 111. Finally, at step 112, the method may process a conversion or a payment to the holder for the value of the matured instruments and any additional payments due.

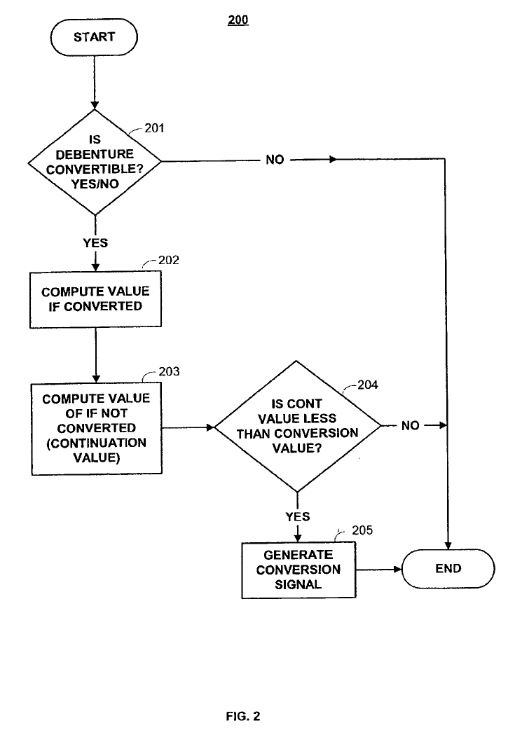

FIG. 2 is a flowchart of illustrative steps involved in determining whether to convert an instrument, in accordance with some embodiments of this invention. The method 200, at step 201 determines whether the instrument is convertible. If not, the method ends. If the instrument is convertible, the method, at step 202, computes the value of the instrument if converted. At step 203, the method computes the value of the instrument if not converted, termed the “continuation value.” At 204, the method determines whether the continuation value is less than the conversion value. If so, a signal to convert is generated at step 205. If not, the method ends.

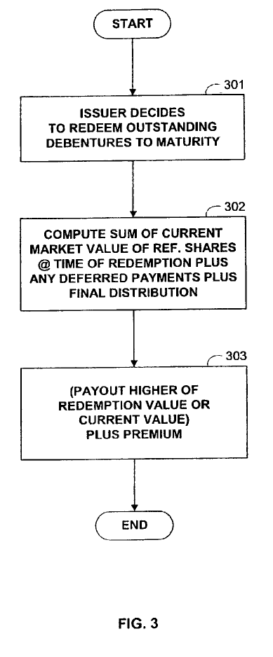

FIG. 3 is a flowchart of illustrative steps involved in redeeming the convertible instrument, as shown at step 103 of FIG. 1. The method 300 may be used when, for example, the issuer decides to redeem instruments issued under one offering document. At step 301, the issuer decides that it no longer wishes to keep the instruments outstanding and that it wants to redeem the instruments. Also at step 302, the method calculates the current market value of underlying shares at the time of redemption plus any deferred payments. At step 303, the method pays out the appropriate redemption amount plus any additional amount, as calculated at step 302.

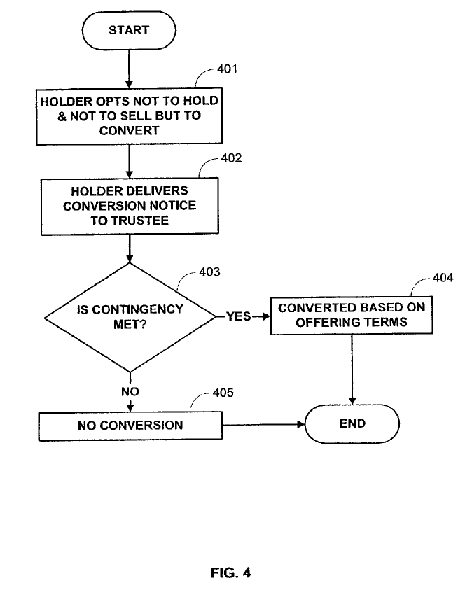

FIG. 4 is a flowchart of illustrative steps involved in converting convertible debt instruments as shown in FIG. 1 at step 105. The method may be used if, at step 401, the holder determines that it wants to convert the instrument for the underlying security. Under this method, the holder can convert, or exchange depending on the type of instrument, but may incur a penalty. At step 402, the holder delivers a conversion notice to the trustee. At step 403, the method determines whether the conversion may occur by satisfying a contingency. Thus, at step 403, the method directs the instruments that may be converted to step 404, and directs those that may not to step 405. The method at step 404 converts the instruments based on predetermined offering terms.

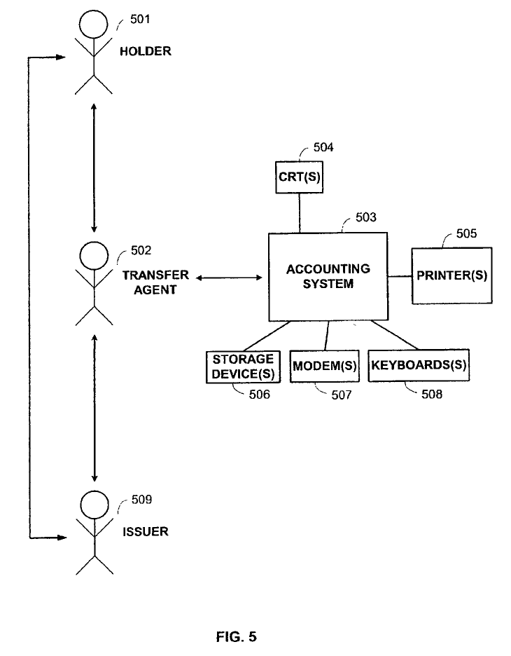

FIG. 5 shows the flow of information in a system for issuing and servicing contingent convertible financial instruments. A potential holder 501 requests an offering document that describes the terms of the security. Upon receiving the offering document and purchasing an instrument from the issuer 509 or through a third party, the transfer agent 502 may track the underlying reference security and service the security using, for example, the methods described in FIGS. 1-4. In doing so, in an exemplary embodiment the transfer agent will use a computerized accounting system 503 capable of tracking the underlying reference security via data lines such as a network (omitted for clarity in FIG. 5) or via modem 507, tracking any dividend and pay-out from the underlying security, making calculations as disclosed in the instrument's offering document, and using a printer 505 to print periodic (e.g., annual) reports and statements reporting the instrument's value, and gains to the holder for tax reporting purposes.

In addition, the accounting system 503 may maintain pricing data (i.e., issue date, reference underlying instrument's price at time of issue, deferred dividends, etc.) in its mass storage system 506. In addition to the data received through the network or modem 507, the data may be inputted into the accounting system using keyboards 508. The system's modem 507 and network lines may be used to transfer funds to a holder or to a third party intermediary and the printer 505 may also print checks that are delivered directly to the third party or to a third party intermediary. Finally, the transfer agent may view the data from the accounting system using a CRT 504 or reports prepared by the accounting system 503 and printed using the system's printer 505.

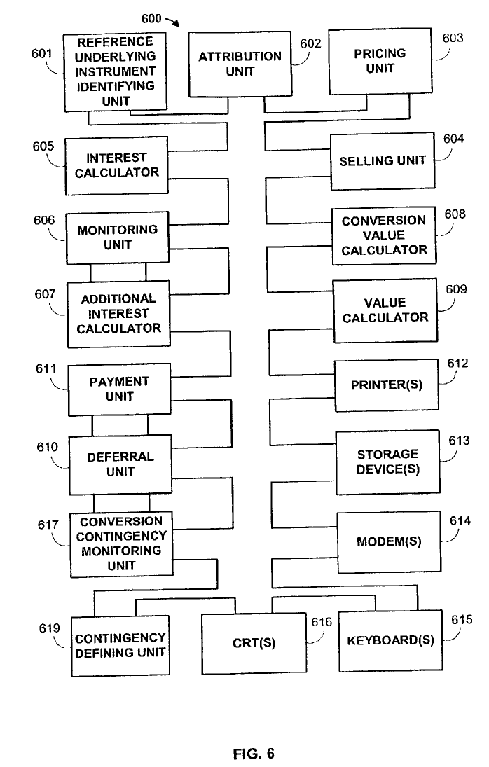

FIG. 6 offers an overview of some embodiments of a system 600 for implementing the method according to the invention. A reference underlying instrument identifying unit 601 is provided to identify (e.g., by user keyboard entry) a reference underlying instrument. An attribution unit 602 is used to attribute a number of the reference underlying instrument's shares to the instrument to be issued. Based on the price of the reference underlying instrument and the attributed number of reference instruments, a pricing unit 603 will establish a price for the instrument to be issued.

A selling unit 604 processes sales of the instrument to interested investors at the price determined by pricing unit 603. An interest calculator 605, throughout the term of the instrument, calculates interest due to holders on a periodic basis. Furthermore, a monitoring unit 606 tracks any dividend or pay-out of the underlying reference security. An additional interest calculator 607 calculates the additional interest owed to holders of the instrument.

If during the term of the instrument, a holder decides to convert the instrument, a conversion value calculator 608 calculates the conversion value of the instrument. The value calculator 609 calculates the value of the instrument at the time of redemption (if the instrument is redeemed early by the issuer), and may also be used at maturity (if the instrument remains outstanding until maturity).

A deferral unit 610 processes the results of interest calculator 605, and additional interest calculator 607, to determine if the calculated amount will be paid or deferred. If the payment amount is not deferred, payment is made by payment unit 611. Furthermore, payment unit 611 processes and makes payment based on the results of conversion value calculator 608, and value calculator 609. Payment may be made by check printed by a printer 612 as commanded by payment unit 611. Alternatively payment may be made via electronic transfer by modem 614. Reports listing payments of interest, and other financial data relevant to the holder for tax reporting purposes or other reportable data are printed using printer 612. Any such reports meant for holders preferably are printed and sent to holders periodically, and at least annually. Other reports may be required by regulatory agencies and are printed when required by the relevant regulations. Storage 613, modems 614, keyboards 615, and CRT 616 are used by the separate units of system 600, in a manner similar to that described in connection with FIG. 5. Conversion contingency unit 617 determines whether a contingency is satisfied and ultimately whether a conversion may occur. A contingency defining unit 619 is used to define contingencies that may be provided for in the financial instruments.

It will be appreciated by those skilled in the art that while many of the functional blocks shown in FIG. 6 might be implemented as separate physical devices, it is possible and indeed desirable to implement many of them by means of a general-purpose computer executing suitable software.

Stated differently, in accordance with the invention a sequence of steps may be performed.

First, the issuer issues a financial instrument indicative of a principal amount and receives money therefor. The amount of money may be a discounted amount defining the yield of the instrument. The instrument may or may not provide for cash interest payments.

The issuer also promises, pursuant to the financial instrument, to repay the principal upon predetermined conditions and according to a predetermined term. The term may be fixed; the instrument may instead permit the issuer to redeem the instrument before the end of the term under specified circumstances.

The issuer also promises, pursuant to the financial instrument, to allow the investor to convert the instrument into shares of stock of the company at a conversion price upon a contingency, the contingency comprising an event, occurring during the term, of shares of stock of the company reaching a value that is in a predetermined relationship with the conversion price. The predetermined relationship may be fixed over the term or may vary under specified circumstances. The conversion may be for a specified number of shares associated with the instrument, or may be based upon the conversion price divided into the par value of the instrument. The manner in which the number of shares relates to the par value of the instrument may be constant over the term of the instrument or may vary under specified circumstances.

Finally, the issuer converts the instrument upon request if the contingency is satisfied.

The contingency may comprise the shares of stock of the company reaching a value that is at least 100% of the conversion price, or at least 110% of the conversion price, or at least 120% of the conversion price.

A corresponding sequence of steps may be performed where the instrument represents shares of preferred stock that are convertible to common stock.

A corresponding sequence of steps may be performed where the instrument represents convertibility or exchangeability into any of a variety of underlying references such as stock, indexes, or other indicia of ownership.

The financial instrument may be an instrument issued by a company with respect to a borrowed principal amount, shares of stock of the company trading at a price. The instrument comprises a provision obligating the company to repay the principal according to a predetermined term, a provision making the instrument convertible into a predetermined number of shares of stock of the company at a predetermined conversion price upon a contingency, and a provision defining the contingency as an event, occurring during the term, of shares of stock of the company reaching a value that is in a predetermined relationship with the conversion price.

The financial instrument may define the contingency as the event of the shares of stock of the company reaching a value that is at least the conversion price, or that is at least 110% of the conversion price, or that is at least 120% of the conversion price. The financial instrument may or may not comprise a provision obligating the company to make interest payments according to a predetermined schedule.

It will be appreciated that while the benefits of the invention have been chiefly described with respect to a stock company, with conversion of debt into shares of stock of the company, other business entities with different ways of describing equity in the entity may equally enjoy the benefits of the invention. For example a non-US entity may offer “American Depository Receipts”(“ADRs”) which represent ownership shares of the entity. Likewise a company could issue a warrant or option giving the holder an opportunity to obtain stock. Convertibility of debt into warrants, options, or ADRs may, with some corporate structures, bring about many of the same benefits as convertibility of debt into stock. Thus, it is possible to describe the invention in a more general way, using the term “indicia of ownership”as a more general term than “shares of stock.” It will be appreciated that while the benefits of the invention have been chiefly described with respect to a debt instrument that is convertible into equity (e.g. stock), such benefits may be likewise realized with respect to a variety of other structures. For example, the invention may be applied to an instrument representing preferred stock which is exchangeable for common stock. The invention may be applied to an instrument representing debt which may be converted into stock of a parent or subsidiary of the issuer. It may be applied to an instrument representing debt of a partnership, which debt may be converted into stock of a related or unrelated entity. More generally the invention may be applied to an instrument which provides for exchangeability of an instrument to any underlying reference, for example financial instruments, commodities, and indexes.

As previously mentioned, it is possible to represent ownership of financial instruments such as those described here by means of physical certificates. Alternatively, and preferably, ownership is recorded by means of bookkeeping entries by an appropriate entity such as a transfer agent. In either case, there is generally an offering document (a collective term which includes a prospectus, prospectus supplement, offering memorandum, or offering circular). The offering document may be a printed document or may be a data file such as a PDF (portable document format) file. The offering document details the terms of the financial instrument. For example, for a convertible debt instrument, the document will have provisions which detail the principal amount, interest payments, convertibility, and contingencies relating to convertibility. Further provisions may set forth, for example, the terms upon which the issuer may redeem the instrument. The offering document is often dozens of pages in length or longer.

Two examples illustrate embodiments of the invention.

### EXAMPLE 1

In November of 2000, Merrill Lynch placed $3.4 billion in zero-coupon convertible debt instruments on behalf of a client. The instruments had a conversion premium of 36% and a 1.5% yield to maturity. The debt instruments included a contingent conversion provision, whereby the investor cannot convert unless the stock reaches more than 110% of the purchase price. This provision made the debt instruments more attractive at a time when the market for zero-coupon debt instruments was nearly saturated.

### EXAMPLE 2

In May of 2002, Merrill Lynch placed $350 million selling bonds on behalf of a client, the bonds convertible into shares of the issuer. The bonds were 20-year no-coupon notes. The bonds provide for a conversion price of 15,863 yen per share, a 45% premium over the closing price for the shares at the time of issuance of the bonds. The instruments include a provision that conversion may be done only if the shares reach a price 10 percent higher than the conversion price.

It is instructive, then, to observe some of the benefits of the invention. As was mentioned above, for some would-be issuers of a convertible debt instrument there is the concern that it would be necessary to count the shares that are the subject of the instrument in the calculation of earnings per share, a preferred measure of corporate performance. But with the accounting rules in effect in at least two countries, with a contingency such as described herein, until the investor exercises the option, the issuer does not have to count such shares in its calculation of earnings per share. This may be advantageous for the issuer.

Thus, a convertible debt instrument with contingent conversion, and systems and methods for offering and servicing the same are provided. One skilled in the art will appreciate that the present invention can be practiced by other than the described embodiments, which are presented for purposes of illustration and not of limitation. Those skilled in the art will have no difficulty devising obvious variations and enhancements of the invention, all of which are intended to fall within the scope of the claims which follow.

1. A method performed with respect to an entity, indicia of ownership of the entity trading at a price, the method comprising the steps of:
issuing a financial instrument indicative of a principal amount and receiving money therefor;
promising, pursuant to the financial instrument, to repay said principal upon predetermined conditions and according to a predetermined term;
promising, pursuant to the financial instrument, to allow a holder of the instrument to convert the instrument into indicia of ownership of the entity at a conversion price upon a contingency, the contingency comprising an event, occurring during the term, of indicia of ownership of the entity reaching a value that is in a predetermined relationship with the conversion price; and
converting the instrument upon the holder's request if the contingency is satisfied.

2. The method of claim 1 wherein the contingency further comprises the indicia of ownership of the entity reaching a value that is at least 110% of the conversion price.

3. The method of claim 1 wherein the contingency further comprises the indicia of ownership of the entity reaching a value that is at least 120% of the conversion price.

4. The method of claim 1 further comprising promising, pursuant to the financial instrument, to make cash interest payments prior to maturity according to a predetermined schedule.

5. The method of claim 1 further comprising the step of issuing the financial instrument as a physical document.

6. A financial instrument issued by an entity with respect to a borrowed principal amount, indicia of ownership of the entity trading at a price, the instrument comprising:
a provision obligating the entity to repay the principal according to a predetermined term;
a provision making the instrument convertible into a predetermined number of indicia of ownership of the entity at a predetermined conversion price upon a contingency;
a provision defining the contingency as an event, occurring during the term, of indicia of ownership of the entity reaching a value that is in a predetermined relationship with the conversion price.

7. The financial instrument of claim 6 wherein the contingency further comprises the indicia of ownership of the entity reaching a value that is at least the conversion price.

8. The financial instrument of claim 6 wherein the contingency further comprises the indicia of ownership of the entity reaching a value that is at least 110% of the conversion price.

9. The financial instrument of claim 6 wherein the contingency further comprises the indicia of ownership of the entity reaching a value that is at least 120% of the conversion price.

10. The financial instrument of claim 6 wherein the instrument further comprises a provision obligating the entity to make cash interest payments prior to maturity according to a predetermined schedule.

11. An offering document offering financial instrument issued by an entity with respect to a borrowed principal amount, indicia of ownership of the entity trading at a price, the instrument comprising:
a provision obligating the entity to repay the principal according to a predetermined term;
a provision making the instrument convertible into a predetermined number of indicia of ownership of the entity at a predetermined conversion price upon a contingency;
a provision defining the contingency as an event, occurring during the term, of indicia of ownership of the entity reaching a value that is in a predetermined relationship with the conversion price.

12. The offering document of claim 11 wherein the contingency further comprises the indicia of ownership of the entity reaching a value that is at least the conversion price.

13. The offering document of claim 11 wherein the contingency further comprises the indicia of ownership of the entity reaching a value that is at least 110% of the conversion price.

14. The offering document of claim 11 wherein the contingency further comprises the indicia of ownership of the entity reaching a value that is at least 120% of the conversion price.

15. A method performed with respect to an entity, indicia of ownership of the entity trading at a price, the method comprising the steps of:
issuing a financial instrument indicative of a principal amount and receiving money therefor;
promising, pursuant to the financial instrument, to repay said principal upon predetermined conditions and according to a predetermined term;
promising, pursuant to the financial instrument, to allow a holder of the instrument to convert the instrument into indicia of ownership of the entity at a conversion price upon a contingency, the contingency being other than the mere passage of time; and
converting the instrument upon the holder's request if the contingency is satisfied.

16. The method of claim 15 wherein the contingency further comprises an event, occurring during the term, of indicia of ownership of the entity reaching a value that is in a predetermined relationship with the conversion price.

17. The method of claim 15 wherein the contingency further comprises the indicia of ownership of the entity reaching a value that is at least 110% of the conversion price.

18. The method of claim 15 wherein the contingency further comprises the indicia of ownership of the entity reaching a value that is at least 120% of the conversion price.

19. The method of claim 15 further comprising promising, pursuant to the financial instrument, to make cash interest payments prior to maturity according to a predetermined schedule.

20. The method of claim 15 further comprising the step of issuing the financial instrument as a physical document.

21. A financial instrument issued by an entity with respect to a borrowed principal amount, indicia of ownership of the entity trading at a price, the instrument comprising:
a provision obligating the entity to repay the principal according to a predetermined term;
a provision making the instrument convertible into a predetermined number of indicia of ownership of the entity at a predetermined conversion price upon a contingency;
a provision defining the contingency as an event, occurring during the term, other than the mere passage of time.

22. The financial instrument of claim 21 wherein the contingency further comprises the indicia of ownership of the entity reaching a value that is at least the conversion price.

23. The financial instrument of claim 21 wherein the contingency further comprises the indicia of ownership of the entity reaching a value that is at least 110% of the conversion price.

24. The financial instrument of claim 21 wherein the contingency further comprises the indicia of ownership of the entity reaching a value that is at least 120% of the conversion price.

25. An offering document offering a financial instrument issued by an entity with respect to a borrowed principal amount, indicia of ownership of the entity trading at a price, the instrument comprising:
a provision obligating the entity to repay the principal according to a predetermined term;
a provision making the instrument convertible into a predetermined number of indicia of ownership of the entity at a predetermined conversion price upon a contingency;
a provision defining the contingency as an event, occurring during the term, other than the mere passage of time.

26. The offering document of claim 25 wherein the contingency further comprises the indicia of ownership of the entity reaching a value that is at least the conversion price.

27. The offering document of claim 25 wherein the contingency further comprises the indicia of ownership of the entity reaching a value that is at least 110% of the conversion price.

28. The offering document of claim 25 wherein the contingency further comprises the indicia of ownership of the entity reaching a value that is at least 120% of the conversion price.

29. A method performed with respect to an entity, indicia of ownership of the entity trading at a price, the method comprising the steps of:
issuing a financial instrument and receiving money therefor;
promising, pursuant to the financial instrument, to allow a holder of the instrument to convert the instrument to indicia of ownership of the entity at a conversion price upon a contingency, the contingency comprising an event, occurring during the term, of indicia of ownership of the entity reaching a value that is in a predetermined relationship with the conversion price; and
converting the instrument upon the holder's request if the contingency is satisfied.

30. The method of claim 29 wherein the contingency further comprises the indicia of ownership of the entity reaching a value that is at least 110% of the conversion price.

31. The method of claim 29 wherein the contingency further comprises the indicia of ownership of the entity reaching a value that is at least 120% of the conversion price.

32. A financial instrument issued by an entity, indicia of ownership of the entity trading at a price, the instrument comprising:
a provision making the instrument convertible into a predetermined number of indicia of ownership of the entity at a predetermined conversion price upon a contingency;
a provision defining the contingency as an event, occurring during the term, of indicia of ownership of the entity reaching a value that is in a predetermined relationship with the conversion price.

33. The financial instrument of claim 32 wherein the contingency further comprises the indicia of ownership of the entity reaching a value that is at least the conversion price.

34. The financial instrument of claim 32 wherein the contingency further comprises the indicia of ownership of the entity reaching a value that is at least 110% of the conversion price.

35. The financial instrument of claim 32 wherein the contingency further comprises the indicia of ownership of the entity reaching a value that is at least 120% of the conversion price.

36. An offering document offering a financial instrument issued by an entity, indicia of ownership of the entity trading at a price, the instrument comprising:
a provision making the instrument convertible into a predetermined number of indicia of ownership of the entity at a predetermined conversion price upon a contingency;
a provision defining the contingency as an event, occurring during the term, of indicia of ownership of the entity reaching a value that is in a predetermined relationship with the conversion price.

37. The offering document of claim 36 wherein the contingency further comprises the indicia of ownership of the entity reaching a value that is at least the conversion price.

38. The offering document of claim 36 wherein the contingency further comprises the indicia of ownership of the entity reaching a value that is at least 110% of the conversion price.

39. The offering document of claim 36 wherein the contingency further comprises the indicia of ownership of the entity reaching a value that is at least 120% of the conversion price.

40. A method performed with respect to an entity, indicia of ownership of the entity trading at a price, the method comprising the steps of:
issuing a financial instrument receiving money therefor;
promising, pursuant to the financial instrument, to allow a holder of the instrument to convert the instrument to indicia of ownership of the entity at an exchange price upon a contingency, the contingency being other than the mere passage of time; and
converting the instrument upon the holder's request if the contingency is satisfied.

41. The method of claim 40 wherein the contingency further comprises the indicia of ownership of the entity reaching a value that is at least 110% of the conversion price.

42. The method of claim 40 wherein the contingency further comprises the indicia of ownership of the entity reaching a value that is at least 120% of the conversion price.

43. A financial instrument issued by an entity, indicia of ownership of the entity trading at a price, the instrument comprising:
a provision making the instrument convertible into a predetermined number of indicia of ownership of the entity at a predetermined conversion price upon a contingency, the contingency being other than the mere passage of time.

44. The financial instrument of claim 43 wherein the contingency further comprises the indicia of ownership of the entity reaching a value that is at least the conversion price.

45. The financial instrument of claim 43 wherein the contingency further comprises the indicia of ownership of the entity reaching a value that is at least 110% of the conversion price.

46. The financial instrument of claim 43 wherein the contingency further comprises the indicia of ownership of the entity reaching a value that is at least 120% of the conversion price.

47. An offering document offering a financial instrument issued by an entity, indicia of ownership of the entity trading at a price, the instrument comprising:
a provision making the instrument convertible into a predetermined number of indicia of ownership of the entity at a predetermined conversion price upon a contingency, the contingency being other than the mere passage of time.

48. The offering document of claim 47 wherein the contingency further comprises the indicia of ownership of the entity reaching a value that is at least the conversion price.

49. The offering document of claim 47 wherein the contingency further comprises the indicia of ownership of the entity reaching a value that is at least 110% of the conversion price.

50. The financial instrument of claim 47 wherein the contingency further comprises the indicia of ownership of the entity reaching a value that is at least 120% of the conversion price.

51. A method performed with respect to a first entity, the method comprising the steps of:
issuing a financial instrument and receiving money therefor;
promising, pursuant to the financial instrument, to allow a holder of the instrument to exchange the instrument for indicia of ownership of a second entity at an exchange price upon a contingency, the contingency comprising an event, occurring during the term, of indicia of ownership of the second entity reaching a value that is in a predetermined relationship with the exchange price; and
exchanging the instrument upon the holder's request if the contingency is satisfied.

52. The method of claim 51 wherein the contingency further comprises the indicia of ownership of the second entity reaching a value that is at least 110% of the exchange price.

53. The method of claim 51 wherein the contingency further comprises the indicia of ownership of the second entity reaching a value that is at least 120% of the exchange price.

54. A financial instrument issued by a first entity, the instrument comprising:
a provision making the instrument exchangeable into a predetermined number of indicia of ownership of a second entity at a predetermined exchange price upon a contingency;
a provision defining the contingency as an event, occurring during the term, of indicia of ownership of the second entity reaching a value that is in a predetermined relationship with the exchange price.

55. The financial instrument of claim 54 wherein the contingency further comprises the indicia of ownership of the second entity reaching a value that is at least the exchange price.

56. The financial instrument of claim 54 wherein the contingency further comprises the indicia of ownership of the second entity reaching a value that is at least 110% of the exchange price.

57. The financial instrument of claim 54 wherein the contingency further comprises the indicia of ownership of the second entity reaching a value that is at least 120% of the exchange price.

58. An offering document offering a financial instrument issued by a first entity, the instrument comprising:
a provision making the instrument exchangeable into a predetermined number of indicia of ownership of a second entity at a predetermined exchange price upon a contingency;
a provision defining the contingency as an event, occurring during the term, of indicia of ownership of the second entity reaching a value that is in a predetermined relationship with the exchange price.

59. The offering document of claim 58 wherein the contingency further comprises the indicia of ownership of the entity reaching a value that is at least the conversion price.

60. The offering document of claim 58 wherein the contingency further comprises the indicia of ownership of the entity reaching a value that is at least 110% of the conversion price.

61. The offering document of claim 58 wherein the contingency further comprises the indicia of ownership of the entity reaching a value that is at least 120% of the conversion price.

62. A method performed with respect to a first entity, the method comprising the steps of:
issuing a financial instrument receiving money therefor;
promising, pursuant to the financial instrument, to allow a holder of the instrument to exchange the instrument for indicia of ownership of a second entity at an exchange price upon a contingency, the contingency being other than the mere passage of time; and
exchanging the instrument upon the holder's request if the contingency is satisfied.

63. The method of claim 62 wherein the contingency further comprises the indicia of ownership of the second entity reaching a value that is at least 110% of the exchange price.

64. The method of claim 62 wherein the contingency further comprises the indicia of ownership of the second entity reaching a value that is at least 120% of the exchange price.

65. A financial instrument issued by a first entity, the instrument comprising:
a provision making the instrument exchangeable into a predetermined number of indicia of ownership of a second entity at a predetermined exchange price upon a contingency, the contingency being other than the mere passage of time.

66. The financial instrument of claim 66 wherein the contingency further comprises the indicia of ownership of the second entity reaching a value that is at least the exchange price.

67. The financial instrument of claim 67 wherein the contingency further comprises the indicia of ownership of the second entity reaching a value that is at least 110% of the exchange price.

68. The financial instrument of claim 68 wherein the contingency further comprises the indicia of ownership of the second entity reaching a value that is at least 120% of the exchange price.

69. An offering document offering a financial instrument issued by a first entity, the instrument comprising:
a provision making the instrument exchangeable into a predetermined number of indicia of ownership of a second entity at a predetermined exchange price upon a contingency the contingency being other than the mere passage of time.

70. The offering document of claim 69 wherein the contingency further comprises the indicia of ownership of the entity reaching a value that is at least the conversion price.

71. The offering document of claim 69 wherein the contingency further comprises the indicia of ownership of the entity reaching a value that is at least 110% of the conversion price.

72. The offering document of claim 69 wherein the contingency further comprises the indicia of ownership of the entity reaching a value that is at least 120% of the conversion price.

73. A method performed with respect to an entity, the method comprising the steps of:
issuing a financial instrument and receiving money therefor;
promising, pursuant to the financial instrument, to allow a holder of the instrument to exchange the instrument for an underlying reference at an exchange price upon a contingency, the contingency being other than the mere passage of time; and
exchanging the instrument upon the holder's request if the contingency is satisfied.

74. The method of claim 73 wherein the contingency further comprises the underlying reference reaching a value that is at least 110% of the exchange price.

75. The method of claim 74 wherein the contingency further comprises the underlying reference reaching a value that is at least 120% of the exchange price.

76. A financial instrument issued by a first entity, the instrument comprising:
a provision making the instrument exchangeable into a predetermined number of an underlying reference at a predetermined exchange price upon a contingency, the contingency being other than the mere passage of time.

77. The financial instrument of claim 66 wherein the contingency further comprises the indicia of ownership of the second entity reaching a value that is at least the exchange price.

78. The financial instrument of claim 67 wherein the contingency further comprises the indicia of ownership of the second entity reaching a value that is at least 110% of the exchange price.

79. The financial instrument of claim 68 wherein the contingency further comprises the indicia of ownership of the second entity reaching a value that is at least 120% of the exchange price.

80. An offering document offering a financial instrument issued by a first entity, the instrument comprising:
a provision making the instrument exchangeable into a predetermined number of indicia of ownership of a second entity at a predetermined exchange price upon a contingency the contingency being other than the mere passage of time.

81. The offering document of claim 69 wherein the contingency further comprises the indicia of ownership of the entity reaching a value that is at least the conversion price.

82. The offering document of claim 69 wherein the contingency further comprises the indicia of ownership of the entity reaching a value that is at least 110% of the conversion price.

83. The offering document of claim 69 wherein the contingency further comprises the indicia of ownership of the entity reaching a value that is at least 120% of the conversion price.
